(19) United States
(12) Patent Application Publication
(10) Pub. No.: US 2005/0149915 A1
(43) Pub. Date: Jul. 7, 2005

(54) Methods and apparatus for optimizing a program undergoing dynamic binary translation using profile information

(75) Inventors: Youfeng Wu, Palo Alto, CA (US); Orna Etzion, Haifa (IL)

Correspondence Address: HANLEY, FLIGHT & ZIMMERMAN, LLC, 20 N. WACKER DRIVE, SUITE 4220, CHICAGO, IL, 60606, US

(73) Assignee: Intel Corporation

(21) Appl. No.: 10/747,598

(22) Filed: Dec. 29, 2003

(51) Int. Cl. G06F 9/45

(52) U.S. Cl. 717/137

(57) ABSTRACT

Methods and apparatus for optimizing a program undergoing dynamic binary translation using profile information are disclosed. A disclosed system optimizes foreign program instructions through an enhanced dynamic binary translation process. The foreign program instructions are translated into native program instructions. Loops within the native program instructions are instrumented with profiling instructions and optimized. The profiling information is collected during execution of the loop. After profiling information is collected, the loop may be further optimized by inserting prefetching instructions into the optimized loop. The prefetched loop is then linked back into the native program instructions and is executable.

### TECHNICAL FIELD

The present disclosure pertains to computers and, more particularly, to methods and an apparatus for optimizing a program undergoing dynamic binary translation using profile information.

### BACKGROUND

As processors evolve and/or as new processor families/architectures emerge, existing software programs may not be executable on these new processors and/or may run inefficiently. These problems arise due to the lack of binary compatibility between new processor families/architectures and older processors. In other words, as processors evolve, their instruction sets change and prevent existing software programs from being executed on the new processors unless some action is taken. Authors of software programs may either rewrite and/or recompile their software programs or processor manufacturers may provide instructions to replicate previous instructions. Both of these solutions have their drawbacks. If the author of the program rewrites his program, the end user is often forced to purchase a new version to use with a new machine. The processor manufacturers may choose to replicate existing instructions or maintain the legacy instructions and/or architecture, but this may limit the advances possible to the processor due to cost and limitations of the legacy instructions and architecture.

Dynamic binary translators provide a possible solution to these issues. A dynamic binary translator converts a foreign program (e.g., a program written for an Intel® ×86 processor) into a native program (e.g., a program understandable by an Itanium® Processor Family processor) on a native machine (e.g., Itanium® Processor Family based computer) during execution. This translation allows a user to execute programs the user previously used on an older machine on a new machine without purchasing a new version of software, and allows the processor to abandon some or all legacy instructions and/or architectures.

Dynamic binary translation typically translates the foreign program in two phases. The first phase (e.g., a cold translation phase) translates blocks (e.g., a sequence of instructions) of foreign instructions to blocks of native instructions. These cold blocks are not globally optimized and may also be instrumented with instructions to measure the number of times the cold block is executed. The cold block becomes a candidate for optimization (e.g., a candidate block) after it has been executed a predetermined number of times.

The second phase (e.g., a hot translation phase) begins when a candidate block is executed at least two times a predetermined number of times or a predetermined number of candidate blocks has been identified. The hot translation phase traverses candidate blocks, identifies traces (e.g., a sequence of blocks), and globally optimizes the traces.

### BRIEF DESCRIPTION OF THE DRAWINGS

FIG. 1 is a block diagram of an example system for optimizing a program undergoing dynamic binary translation.

FIG. 2 is block diagram of an example gen-translation module for use with the disclosed system shown in FIG. 1.

FIG. 3 is a block diagram of an example use-translation module for use with the disclosed system shown in FIG. 1.

FIG. 4 is a flowchart representative of example machine readable instructions which may be executed by a device to implement the example system of FIG. 1.

FIG. 5 is a flowchart representative of example machine readable instructions which may be executed by a device to implement one aspect of the cold translation module of FIG. 1.

FIG. 6 is a flowchart representative of example machine readable instructions which may be executed by a device to implement one aspect of the cold translation module of FIG. 1.

FIG. 7 is a first flowchart representative of example machine readable instructions which may be executed by a device to implement one aspect of the hot translation module of FIG. 1.

FIG. 8 is a second flowchart representative of example machine readable instructions which may be executed by a device to implement one aspect of the hot translation module of FIG. 1.

FIG. 9 is a flowchart representative of example machine readable instructions which may be executed by a device to implement one aspect of the hot translation module of FIG. 1.

FIG. 10 is an example set of instructions that contains two loop paths.

FIG. 11 is an example set of instructions that contains two loops to be used with a Least Common Specialization operation.

FIG. 12 is the example set of instructions of FIG. 11 after the Least Common Specialization operation has been applied.

FIG. 13 is a flowchart representative of example machine readable instructions which may be executed by a device to implement the gen-translation module of FIG. 1.

FIG. 14 is a flowchart representative of example machine readable instructions which may be executed by a device to execute the gen-translated instructions.

FIG. 15 is an example data structure to store load addresses.

FIG. 16 is an example flowchart representative of example machine readable instructions which may be executed by a device to implement the profiling function of FIG. 13.

FIG. 17 is an example flowchart representative of example machine readable instructions which may be executed by a device to implement the load instruction identifier of FIG. 2.

FIG. 18 is an example flowchart representative of example machine readable instructions which may be executed by a device to implement the self profiling function of FIG. 16.

FIG. 19 is a flowchart representative of example machine readable instructions which may be executed by a device to implement a cross-profiling function used in the profiling function of FIG. 16.

FIG. 20 is an example flowchart representative of example machine readable instructions which may be executed by a device to implement the use-translation module of FIG. 1.

FIG. 21 is an example flowchart representative of example machine readable instructions which may be executed by a device to implement the profile analyzer of FIG. 3.

FIG. 22 is an example flowchart representative of example machine readable instructions which may be executed by a device to eliminate the redundant prefetching instructions block of FIG. 20.

FIG. 23 is a block diagram of an example computer system which may execute the machine readable instructions represented by the flowcharts of FIGS. 4, 5, 6, 7, 8, 9, 13, 14, 16, 17, 18, 19, 20, 21, and/or 22 to implement the apparatus of FIG. 1.

### DETAILED DESCRIPTION

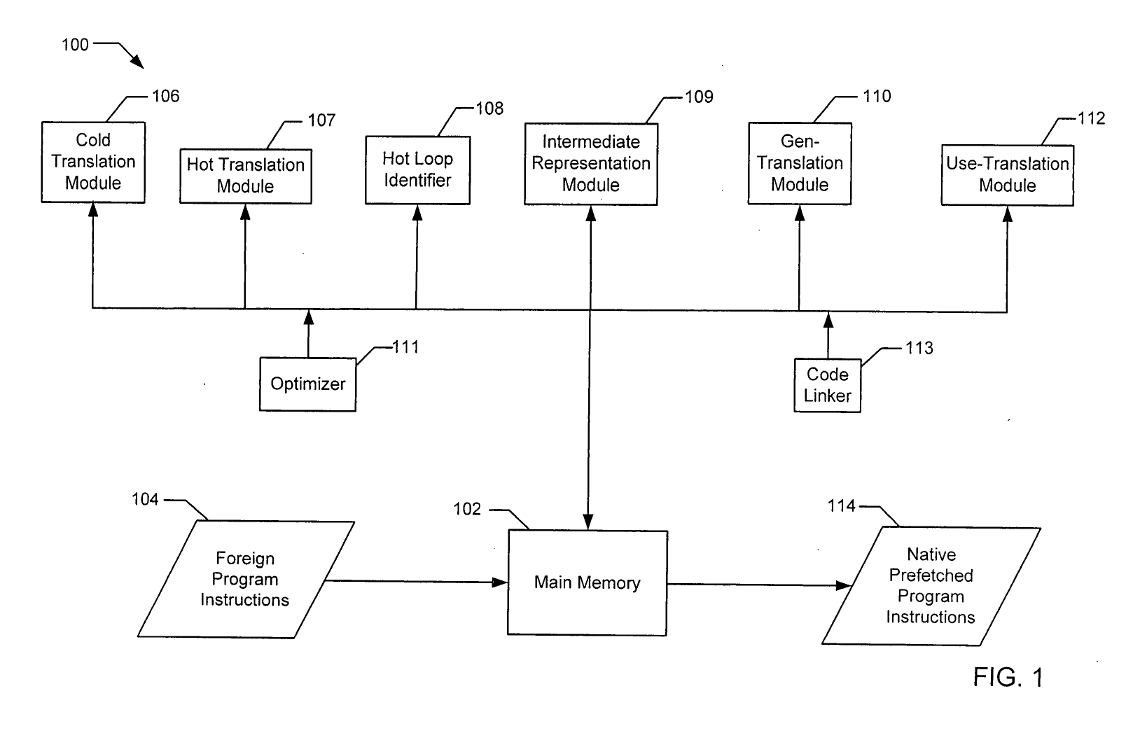

FIG. 1 is a block diagram of an example apparatus 100 to optimize a program. The apparatus 100 may be implemented as several components of hardware each configured to perform one or more functions, may be implemented in software or firmware where one or more programs are used to perform the different functions, or may be a combination of hardware, firmware, and/or software. In this example, the apparatus 100 includes a main memory 102, a cold translation module 106, a hot translation module 107, a hot loop identifier 108, an intermediate representation module 109, a gen-translation module 110, an optimizer 111, a use-translation module 112, and a code linker 113.

The main memory device 102 may include dynamic random access memory (DRAM) and/or any other form of random access memory. The main memory device 102 also contains memory for a cache hierarchy. The cache hierarchy may include a single cache or may be several levels of cache with different sizes and/or access speeds. For example, the cache hierarchy may include three levels of on-board cache memory. A first level of cache may be the smallest cache having the fastest access time. Additional levels of cache progressively increase in size and access time.

As shown schematically in FIG. 1, the example apparatus 100 receives foreign program instructions 104 and converts them into optimized native prefetched program instructions 114. The foreign program instructions 104 may be any type of instructions which are part of an instruction set for a foreign processor. For example, the foreign program instructions 104 may be instructions originally intended to be executed on an Intel® ×86 processor, but which a user now desires to execute on a different type of processor, such as an Intel Itanium® processor. These instructions may include, but are not limited to, load instructions, store instructions, arithmetic functions, conditional instructions, execution flow control instructions, and/or floating point operations.

The cold translation module 106 translates blocks of the foreign program instructions 104 into native program instructions. For example, the cold translation module 106 may be executed on an Intel Itanium® based computer and may receive instructions for an Intel® ×86 processor. The cold translation module 106 translates the foreign Intel® ×86 instructions into native Itanium® Processor Family instructions. The cold translation module 106 may not optimize the native instructions, but after cold translation, the native instructions are executable on the native platform (e.g., the Itanium® based computer in this example).

The hot translation module 107 is configured to translate traces (e.g., a sequence of blocks) of the foreign program instructions 104 into native program instructions and may provide some level of optimization. The hot translation module 107 may use the intermediate representation module 109 to convert the foreign program instructions 104 into an intermediate representation (IR) (described below). The hot translation module 107 may also use the optimizer 111 to optimize the IR before the IR is translated into native program instructions. Some of the traces translated by the hot translation module 107 are loops and instrumented the IR with instructions to measure the loop's hot execution trip_count.

The hot loop identifier 108 identifies loops which should be optimized using profiling information. The hot loop identifier 108 examines the source instructions and attempts to identify loops which meet predefined criteria. For example, the hot loop identifier 108 may seek a loop that contains a load instruction that does not access stack data and does not have a loop invariant data address. Although this example uses load instructions, other instructions meeting different criteria may alternatively or additionally be identified.

The intermediate representation module 109 is configured to translate foreign program instructions 104 into an intermediate representation (IR). The IR may be instructions that are not directly executable on the native platform. The IR may be an interpreted language (e.g., Java's bytecode) or may be similar to a machine code. The IR may be used to facilitate the optimization of the native program instructions. The intermediate representation module 109 may also be configured to translate the IR into native program instructions.

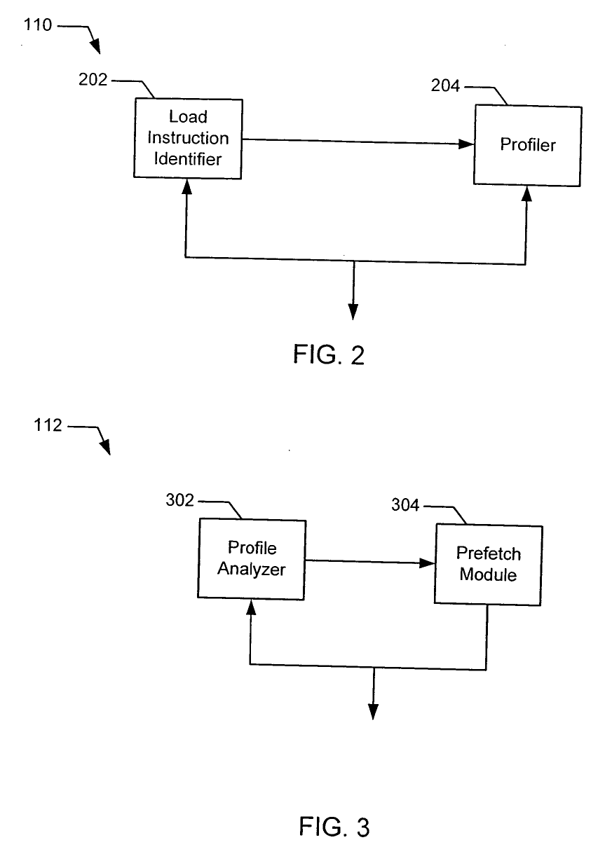

The gen-translation module 110 analyzes the IR of the loops of instructions identified by the hot loop identifier 108 (e.g., hot loops) and instruments the IR with profiling instructions to collect profile information. In the example of FIG. 2, the gen-translation module 110 comprises a load instruction identifier 202 and a profiler 204.

The load instruction identifier 202 examines the loops and identifies load instructions within the loops. The profiler 204 inserts profiling instructions into an IR of the loop to collect information about the load instructions identified by the load instruction identifier 202. As the loops are executed, the profiling instructions are also executed to allow the profiler 204 to collect information to be used to optimize the loops. Examples of information collected by the profiling instructions include, but are not limited to, stride values associated with load instructions and/or a number of times data is reused.

The use-translation module 112 analyzes the profile information collected by the profiler 204 and inserts prefetching instructions into the IR of the loop to be prefetched. The prefetched IR is then translated into the native prefetched program instructions. In the example of FIG. 3, the use-translation module 112 comprises a profile analyzer 302 and a prefetch module 304.

The profile analyzer 302 analyzes profile information collected by the profiler 204 and classifies each load instruction based on the profile information for the load instruction. Example classifications are single stride loads, multiple stride loads, cross stride loads and/or base loads of a cross stride load.

The prefetch module 304 further optimizes the native program instructions by inserting prefetching instructions into an IR of the native program instructions. The IR is then translated to produce native prefetched program instructions 114. Prefetching instructions are used to reduce latency times associated with load instructions accessing areas of the main memory 102 which may have slower access times.

The optimizer 111 is used to produce optimized program instructions. The optimizer 111 may be any type of software optimizer such as optimizers found in modern C/C++ compilers. The optimizer 111 may be configured to optimize the IR generated by the intermediate representation module 109 or may be configured to optimize native program instructions. A person of ordinary skill in the art will appreciate that the optimizer 111 may be implemented using several different methods well known in the art. The level of optimization may be adjusted by a user or by some other means.

The code linker 113 links blocks and/or traces of translated foreign program instructions translated into the native program instructions and allows the native prefetched program instructions 114 to be executed with non-prefetched native program instructions. The code linker 113 may link the native program instructions by replacing a branch instruction's branch address or a jump instruction's destination address with the start address of the native program instructions. The code linker 113 may be used by, but not limited to, the hot translation module 107, the gen-translation module 110, and/or the use-translation module 112 to link the outputs of the respective modules to the native program instructions.

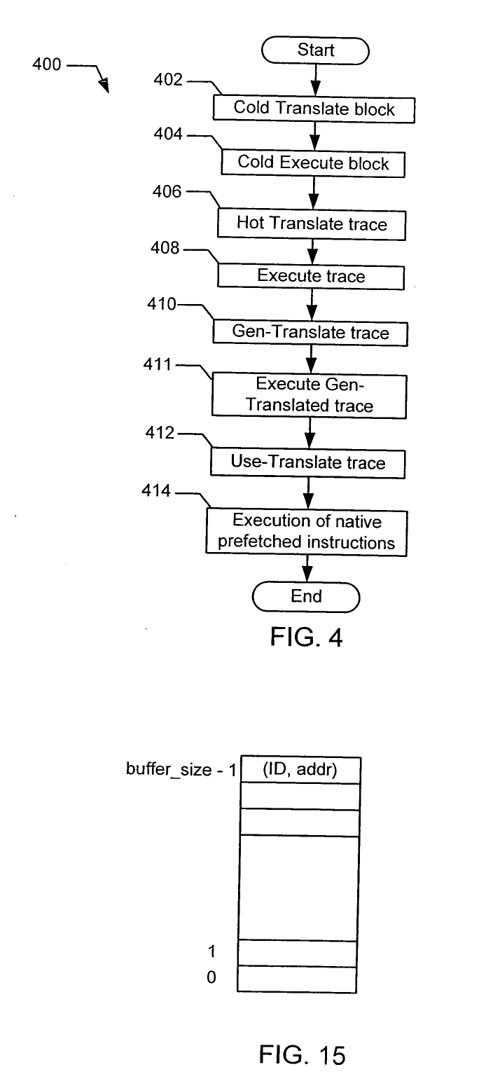

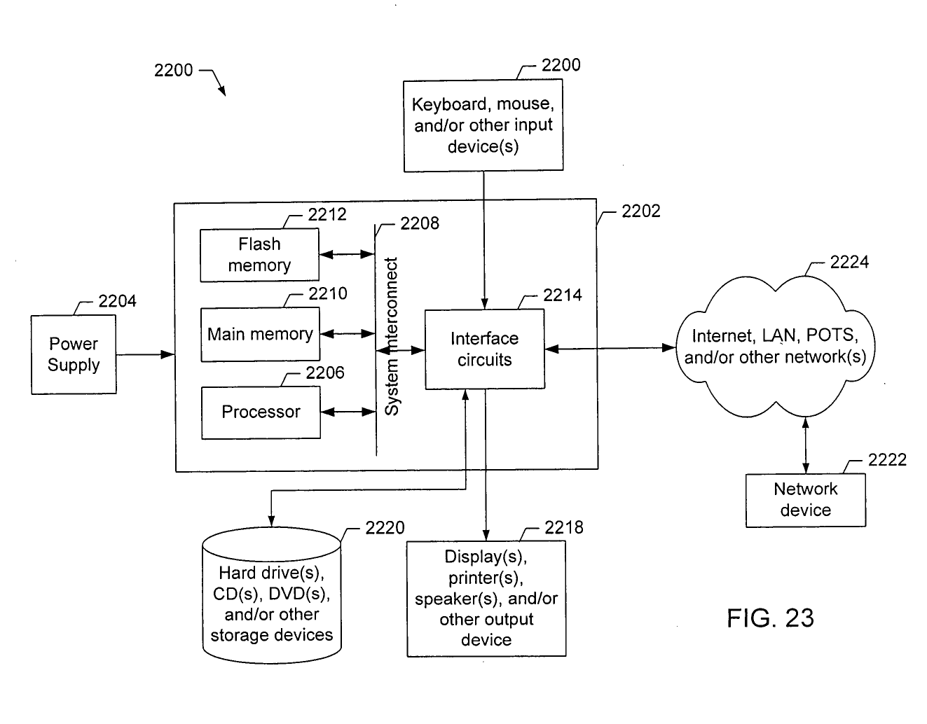

A flowchart representative of example machine readable instructions for implementing the apparatus 100 of FIG. 1 is shown in FIG. 4. In this example, the machine readable instructions comprise a program for execution by a processor such as the processor 2206 shown in the example computer 2200 discussed below in connection with FIG. 23. The program may be embodied in software stored on a tangible medium such as a CD-ROM, a floppy disk, a hard drive, a digital versatile disk (DVD), or a memory associated with the processor 2206, but persons of ordinary skill in the art will readily appreciate that the entire program and/or parts thereof could alternatively be executed by a device other than the processor 2206 and/or embodied in firmware or dedicated hardware in a well known manner. For example, any or all of the cold translation module 106, the hot translation module 107, the hot loop identifier 108, the intermediate representation module 109, the gen-translation module 110, the optimizer 111, the use-translation module 112, the code linker 113, the load instruction identifier 202, the profiler 204, the profile analyzer 302, and the prefetch module 304 could be implemented by software, hardware, and/or firmware. Further, although the example program is described with reference to the flowchart illustrated in FIG. 4, persons of ordinary skill in the art will readily appreciate that many other methods of implementing the example apparatus 100 may alternatively be used. For example, the order of execution of the blocks may be changed, and/or some of the blocks described may be changed, eliminated, or combined.

The example process 400 of FIG. 4 begins by receiving a software program at least partially consisting of foreign program instructions 104. During a cold translation phase, the cold translation module 106 translates blocks of the foreign program instructions 104 into native program instructions (block 402). The resulting blocks of native program instructions are not optimized, but are executable by the processor 2206. After some predefined condition is satisfied during execution of the cold translated blocks (block 404), a hot translation or a gen-translation phase begins, depending on the conditions satisfied. The hot translation module 107 translates the traces of foreign program instructions that have met the predefined condition into native program instructions and may insert instructions to determine a loop's hot execution trip_count (block 406). The hot translation module 107 may also optimize the native program instructions. As the hot translated traces are executed (block 408) and predefined criteria are met, a gen-translation phase begins (block 410). During the gen-translation phase (block 410), a trace that satisfied the predefined criteria is identified by the gen-translation module 110 and then hot translated and modified to create a trace of native program instructions instrumented with profiling instructions. The trace of native program instructions instrumented with profiling instructions are linked back into the program and executed along with the remainder of the program (block 411). Profiling information, such as a load instruction's stride, is collected by the profiler 204 during execution of the program and later analyzed by the profile analyzer 302 during a use-translation phase (block 412). The prefetch module 304 uses the results of the profile analyzer 302 to further optimize blocks of native program instructions by inserting prefetching instructions. The resulting native prefetched program instructions 114 are linked back into the program by the code linker 113 and the native prefetched program instructions may then be executed as part of the overall translated program (block 414). A person of ordinary skill in the art will readily appreciate that different blocks and/or traces within the program may be in different stages of the example process 400. For example, one trace may be in a hot translation phase, while another loop may already have had prefetch instructions inserted.

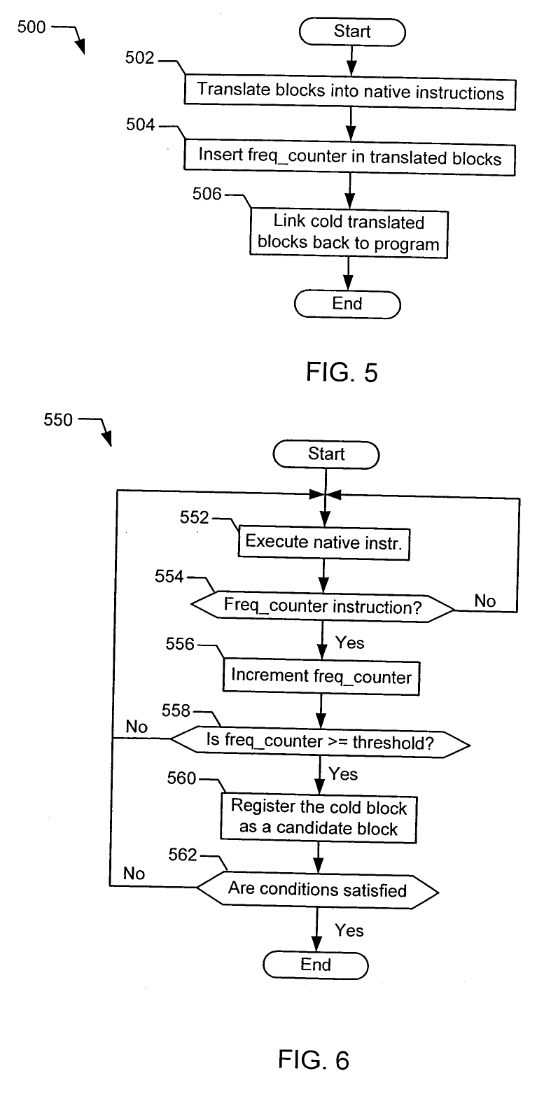

As mentioned above the example process 400 of FIG. 4 begins by receiving a software program at least partially consisting of blocks of foreign program instructions 104. The cold translation module 106 translates the blocks of foreign program instructions 104 into native instructions (e.g., translates foreign ×86 instructions to native Itanium® Processor Family instructions). An example cold translation process is shown in FIG. 5.

The example cold translation process 500 of FIG. 5 begins by translating blocks of foreign instructions into native instructions (block 502). One method to implement the translation is to have an instruction database or lookup table. For each foreign instruction, the cold translation module 106 may refer to the instruction database and find a corresponding native instruction and replace the foreign instruction with the native instruction. A counter (e.g., a freq_counter) is also inserted into each block of translated instructions to record the number of times each block of translated instructions is executed and the number of times the block branches to another block (block 504). The cold translated blocks are linked back to the program by the code linker 113 (block 506) and are executable by the processor 2206.

After the blocks of foreign instructions are cold translated, control returns to block 404 of FIG. 4. The program including the cold translated blocks is cold executed (block 404). An example cold execution process is shown in FIG. 6. Although FIG. 6 illustrates execution of cold translated instructions, a transition between execution of cold translated instructions and hot translated instructions may occur. For ease of discussion, FIG. 6 only illustrates the execution of the cold translated instructions.

The example cold execution process 550 begins by executing the program including the cold translated blocks (block 552). As the processor 2006 executes the program including the blocks of cold translated instructions (block 552), the frequency counter instructions in the cold blocks will be executed (block 554). A freq_counter instruction will be executed whenever a block of native code is entered. When a frequency counter instruction is executed (block 554), the corresponding freq_counter is updated (block 556). After the freq_counter is updated (block 556), the cold translation module 106 examines the value of the freq_counter to determine if its value is greater than a first predetermined threshold (block 558). If the value of the freq_counter is less than the first predetermined threshold (block 558), control returns to block 552 until another freq_counter instruction is encountered. If the cold translation module 106 determined that the value of a freq_counter exceeds the predetermined threshold (block 558), the cold block is registered as a candidate block (block 560). The cold translation module 106 may register the candidate block by creating a list of candidate blocks or may use some other method. The cold translation module 106 then determines if conditions are satisfied to proceed to a hot translation phase (block 562). The cold translation module 106 may examine the number of times a candidate block has been executed (e.g., examine the freq_counter) and the number of candidate blocks that have been registered. If either condition is satisfied, control returns to block 406 of FIG. 4.

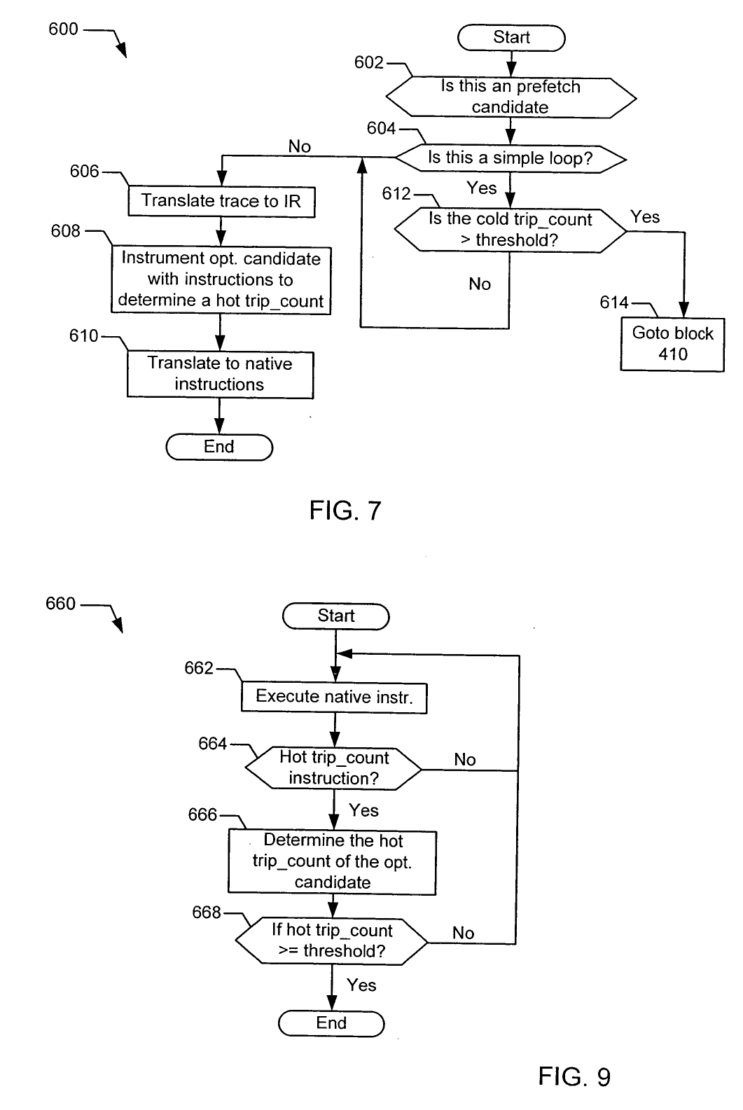

After a predetermined number of cold translated blocks have been identified with freq_counters that exceed the predetermined threshold and/or after a single cold translated block has been identified multiple times, the identified cold translated blocks enter a hot translation phase (block 406). The hot translation module 107 translates a trace of foreign program instructions into native program instructions and may add instructions to determine the trace's hot execution trip count and/or may optimize the trace. An example hot translation process is shown in FIG. 7.

The example hot translation process 600 of FIG. 7 begins by analyzing the traces in the blocks associated with the freq_counters that exceed the predetermined threshold (block 602). The hot loop identifier 108 attempts to identify a trace associated with the freq_counters as a prefetch candidate (block 602). An example prefetch candidate is a loop with a load instruction that (1) does not access a stack register (e.g., a load instruction which does not access stack registers such as the ×86 registers esp and ebp) and (2) does not have a loop invariant load address (e.g., a load instruction whose source address does not change on iterations of the loop).

After a prefetch candidate is identified (block 602), the prefetch candidate is examined to determine if the prefetch candidate is a simple loop (e.g., a loop with primarily floating point instructions) (block 604). If the prefetch candidate is not a simple loop, the intermediate representation module 109 generates an IR of the prefetch candidate (block 606) and the IR is instrumented with instructions to determine the prefetch candidate's hot execution trip_count (block 608). The instructions to determine the prefetch candidate's hot execution trip_count may be inserted into the loop's pre-head block (e.g., a block of instructions preceding the loop) and the loop's entry block. Instructions are inserted in the loop's entry block to update a counter to track the number of times the loop's body is iterated. A loop's hot execution trip_count is equal to the number of times the loop body is iterated divided by the number of times the loop is entered. The IR of the prefetch candidate is translated into native program instructions and linked back into the program (block 610). Control then returns to block 408.

If the prefetch candidate is a simple loop, the prefetch loop's cold execution trip_count is examined (block 612). The cold execution trip_count is similar to the hot execution trip_count but is calculated at the end of cold execution. The cold execution trip_count may be calculated from data that may be collected during the cold execution phase and during the collection of freq_counter data, such as the cold execution frequency of the loop entry block (e.g., Fe) and the cold execution frequency of the loop back edge (e.g., Fx). An example cold execution trip_count calculation may be represented as:

$$trip\_count = \{ \begin{matrix}Fe & if Fe \leq {\sum }_{x ∈ back edges}^{} Fx \\ \frac{Fe}{Fe - {\sum }_{x ∈ back edges}^{} Fx} & otherwise\end{matrix}$$

If the prefetch candidate's cold execution trip_count is greater than a predetermined cold execution trip_count threshold (block 612), the control advances to block 410 of FIG. 4 and a gen-translation phase begins. Otherwise, control advances to block 606.

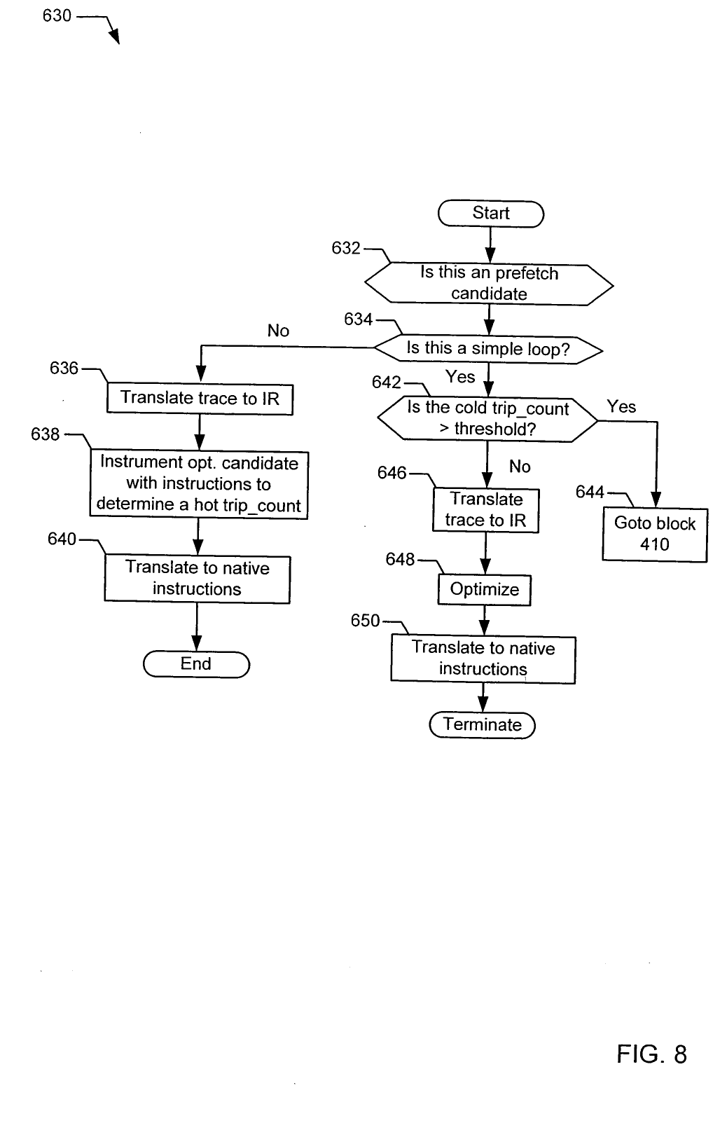

Another example hot translation process 630 is shown in FIG. 8. Blocks 632-644 of the example hot translation process 630 of FIG. 8 are identical to blocks 602-614 of the example hot translation process 600 of FIG. 7. Thus, a description of those blocks will not be repeated here. In the first example hot translation process 600, the simple loop is instrumented with instructions to determine the hot execution trip_count after the simple loop's cold execution trip_count is determined to be less than the cold execution trip_count threshold. In the second example hot translation process 630, the intermediate representation module 109 generates an IR of the simple loop (block 646) and is optimized by the optimizer 111 (block 648). The optimizer 111 may optimize the IR in a manner typical of the optimization that occurs during a compilation process. A person of ordinary skill in the art will readily appreciate that generating an IR of the hot loop before optimizing the hot loop may be skipped if the optimization may be performed without the IR. The optimized IR is then translated to native program instructions (block 650) and then is linked back to the native program by the code linker 113 and executed with the native program instructions. The example process 630 ends and example process 400 then terminates for this particular simple loop because no further optimization will occur for this simple loop, although other traces of the program may still be optimized.

After the traces of program instructions are hot translated (block 406), control returns to block 408 of FIG. 4. The program including the hot translated traces is then executed (block 408). An example execution process is shown in FIG. 9. Although FIG. 9 illustrates execution of hot translated instructions, a transition between execution of cold translated instructions and hot translated instructions may occur. For ease of discussion, FIG. 9 only illustrates the execution of the hot translated instructions.

The example execution process 660 begins by executing the program including the hot translated traces (block 662). Execution of the native program instructions continues until a trip_count instruction (e.g., an instruction inserted to calculate the value of the trip_count during execution of the hot translated instructions) (block 664) is executed. If a trip_count instruction is executed, control advances block 666.

At block 666, the hot loop identifier 108 examines the value of the trip_count associated with the trip_count instruction. If a prefetch candidate's trip_count exceeds the second predetermined threshold (blocks 668), the loop is identified as a hot loop (e.g., a loop to be gen-translated) and control returns to block 410 of FIG. 4. If the trip_count is less than the second predetermined threshold (block 668), control returns to block 662 until another trip_count instruction is executed.

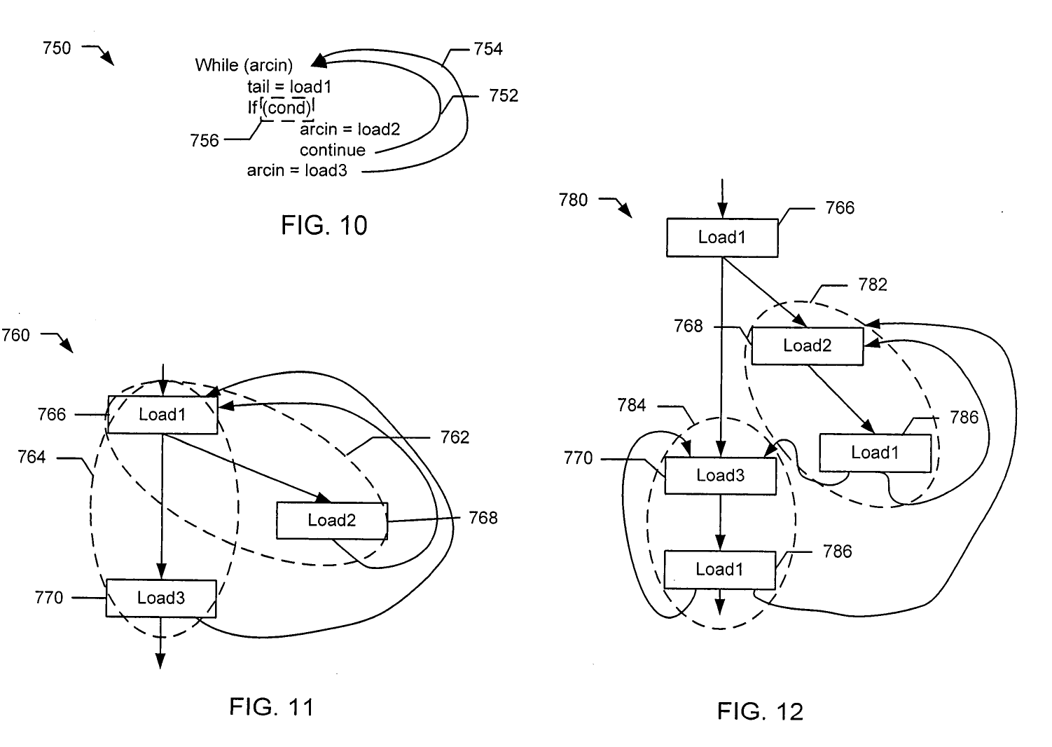

One potential problem the hot loop identifier 108 may encounter using the load instruction criteria defined above is the trace identified may be executed infrequently after the cold translation process 500. For example, FIG. 10 shows a while loop with two paths the program flow may take (e.g., loop1 752 and loop2 754) depending on the value of cond 756. If the value of cond 756 is such that loop1 752 is executed frequently during cold translation, the hot loop identifier 108 may determine that loop1 752 is an optimization candidate. If the value of cond 756 is such that the loop1 752 is rarely executed outside of the cold translation phase, optimizing the loop1 752 may not be beneficial to the overall performance of the program as the loop2 754 may not be recognized and prefetched. Also, an increase in overhead associated with collecting profiling information and the potential to lose prefetching opportunities make identifying loop1 752 as an optimization candidate a bad choice.

One method to help prevent this situation from occurring is to use a Least Common Specialization (LCS) operation before the native instructions are executed (block 552). The LCS operation identifies a block of instructions in a loop that is least common with other loops and rotates the loop such that the least common block of instructions becomes the head of the loop (e.g., a loop head). The loop head is not shared with other loops and this allows other loops to be independently recognized. FIG. 11 illustrates an example set of instructions containing two loops (loop1 762 and loop2 764) and FIG. 12 illustrates the example set of instructions after the LCS operation has rotated blocks of instructions.

FIG. 11 represents a set of instructions comprising two loops (e.g., loop1 762 and loop2 764) and three blocks of instructions (e.g., a load1 block 766, a load2 block 768, and a load3 block 770). The load1 block 766 is common to both loop1 762 and loop2 764. The hot loop identifier 108 identifies the load3 block 770 as the least common block in loop2 764 and identifies the load 2 block 768 as the least common block in loop1 762.

FIG. 12 illustrates the set of instructions of FIG. 11 after the LCS operation has been applied. The hot loop identifier 108 applies the LCS operation to rotate loop1 762 such that the load2 block 768 is the loop head of loop3 782 and to duplicate the load1 block 766 as a redundant block 786 rotated after the load2 block 768. Loop2 764 is rotated such that the load3 block 770 is the head of loop4 784 and the load1 block 766 is duplicated after the load3 block 770. Loop3 782 and loop4 784 do not share a common block (e.g., load1 766 of FIG. 11) as they did in FIG. 11 and the two loops may, thus, be independently examined to determine if either or both should be identified as an optimization candidate.

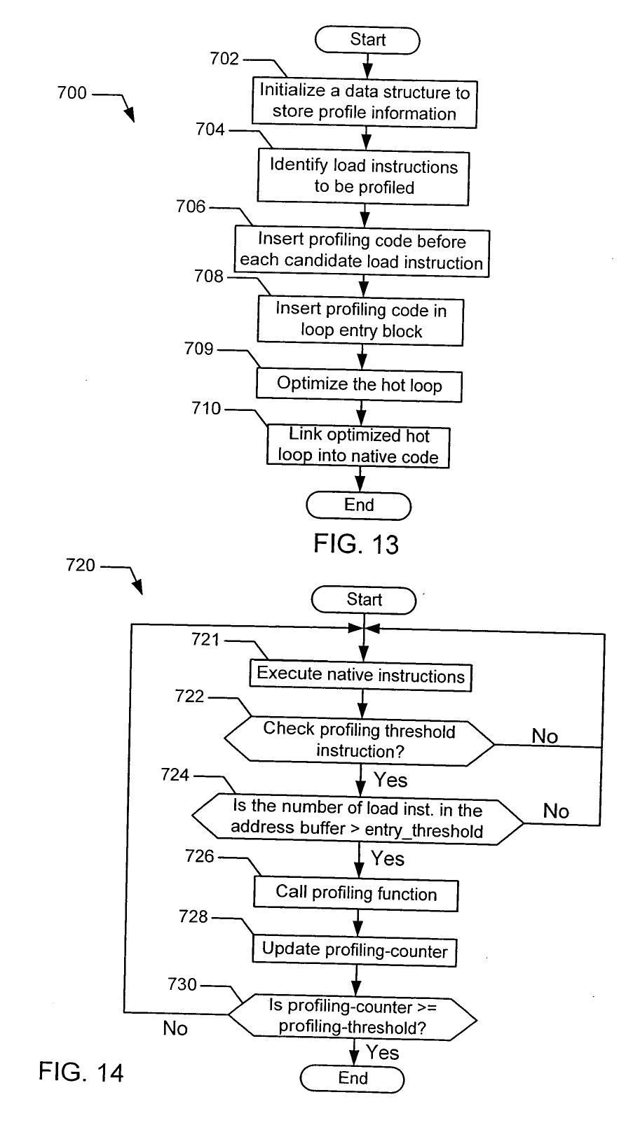

Returning to block 410 of FIG. 4, the example gen-translation process of FIG. 13 begins by initializing a data structure to store profiling information for the loop being optimized (block 702). An example data structure may include, but is not limited to, fields for storing stride information, various counter values, pointers to foreign instructions for the loop, and an address buffer (e.g., an array of load addresses to be profiled). After the data structure is initialized (block 702), the load instruction identifier 202 identifies load instructions within the hot loop (block 704). Control then advances to block 706.

At block 706, the intermediate generator 109 creates an IR of the hot loop's corresponding foreign program instructions and the profiler 204 inserts profiling instructions before each load instruction in the hot loop's IR. An example profiling instruction that may be inserted before a load instruction is a set of instructions which assigns a unique identification tag (ID) to each load instruction, stores the ID and a data address of the load instruction in the address buffer, and adjusts an index variable of the address buffer. As load instructions are identified, the IDs may be assigned from small to large within the hot loop, which facilitates the profiling of the load instructions.

An example implementation of an address buffer is shown in FIG. 15. The address buffer of FIG. 15 is a one-dimensional array with a predetermined size that stores the ID and the data address of a load instruction in an entry of the array. Other implementations may include using a linked list to store the ID and data address of the load instruction or a two-dimensional array using the ID as an index into the array. The address buffer may be used to store data addresses of load instructions in order to profile several load instructions at one time and reduce execution overhead associated with transition from the translated code to the profiling routine (e.g., saving and/or restoring register states).

After inserting the profiling code before the candidate load instructions (block 706), the profiler 204 inserts additional profiling code in the IR of the hot loop's entry block (block 708). The additional profiling instructions are used to determine if the number of load addresses in the address buffer is greater than a profiling threshold. An example method to determine the number of load addresses in the address buffer is to examine the address buffer's index variable. The index variable should indicate the number of entries in the buffer.

After the hot loop's IR has been instrumented with the profiling instructions (blocks 706 and 708), the hot loop's IR may be optimized by the optimizer 111 to produce optimized program instructions (block 709). The optimization may be similar to the optimization in block 648 of FIG. 8. Any of those well known methods may be used here. The intermediate representation module 109 translates the optimized IR into native program instructions. The native program instructions are then linked back into the native program by the code linker 113 and replace the loop before profiling the instructions (block 710).

After the traces of program instructions are gen-translated (block 410), control returns to block 411 of FIG. 4. The program including the gen-translated traces (e.g., the results of block 410) is then executed (block 408). An example execution process is shown in FIG. 14. Although the FIG. 14 illustrates execution of a gen-translated trace, a cold block or a hot trace may also be executed.

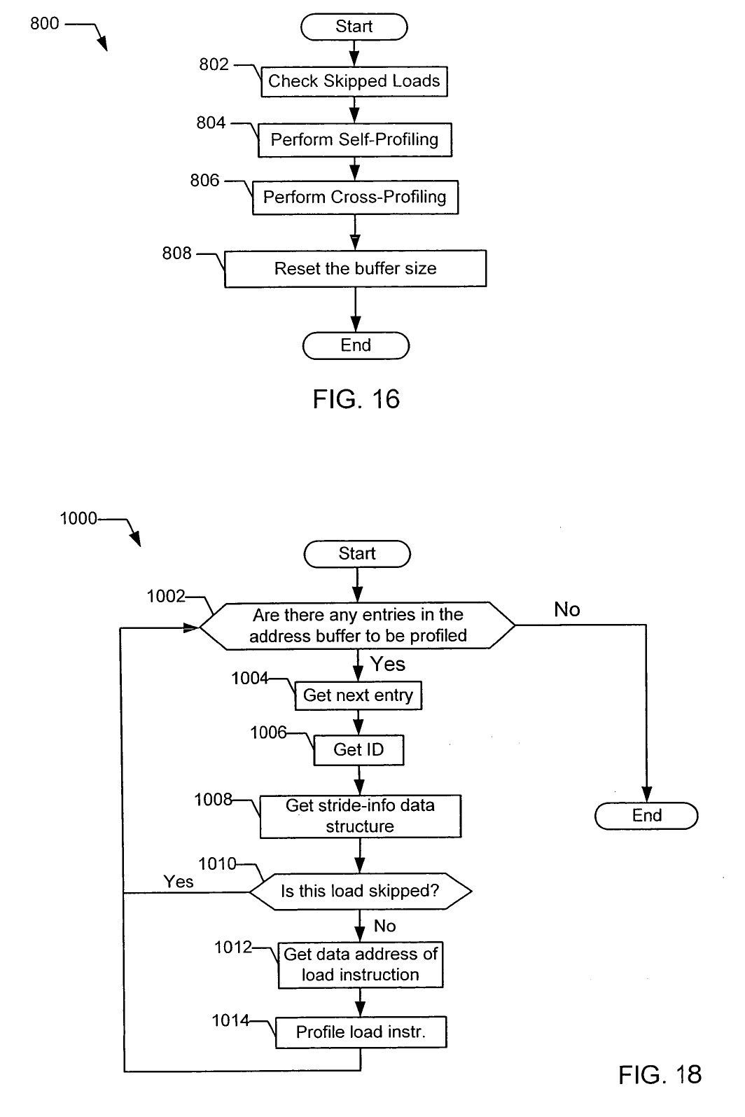

The example execution process 720 of FIG. 14 begins by executing the native program instructions (block 721). During execution of the native program instructions (block 721), the profiling instructions are also executed, the profile information is collected, and an instruction to check the profiling threshold (i.e., one of the profiling instructions instrumented at block 708 of FIG. 13) will periodically be executed. When such an instruction is executed (block 722), the number of load addresses in the address buffer is compared to a profiling threshold (block 724). If the number of load addresses in the address buffer is less than the entry_threshold (e.g., an address buffer entry threshold) (block 724), control returns to the block 721. Otherwise, the profiler 204 may collect the profile information for the load instructions stored in the address buffer (block 726). The profiler 204 collects information such as a difference between addresses issued by the same load instruction, an address difference between pairs of load instructions, and a number of times a pair of addresses access a same cache line. An example profiling function 800 that may be executed to implement the profiler 204 is shown in FIG. 16.

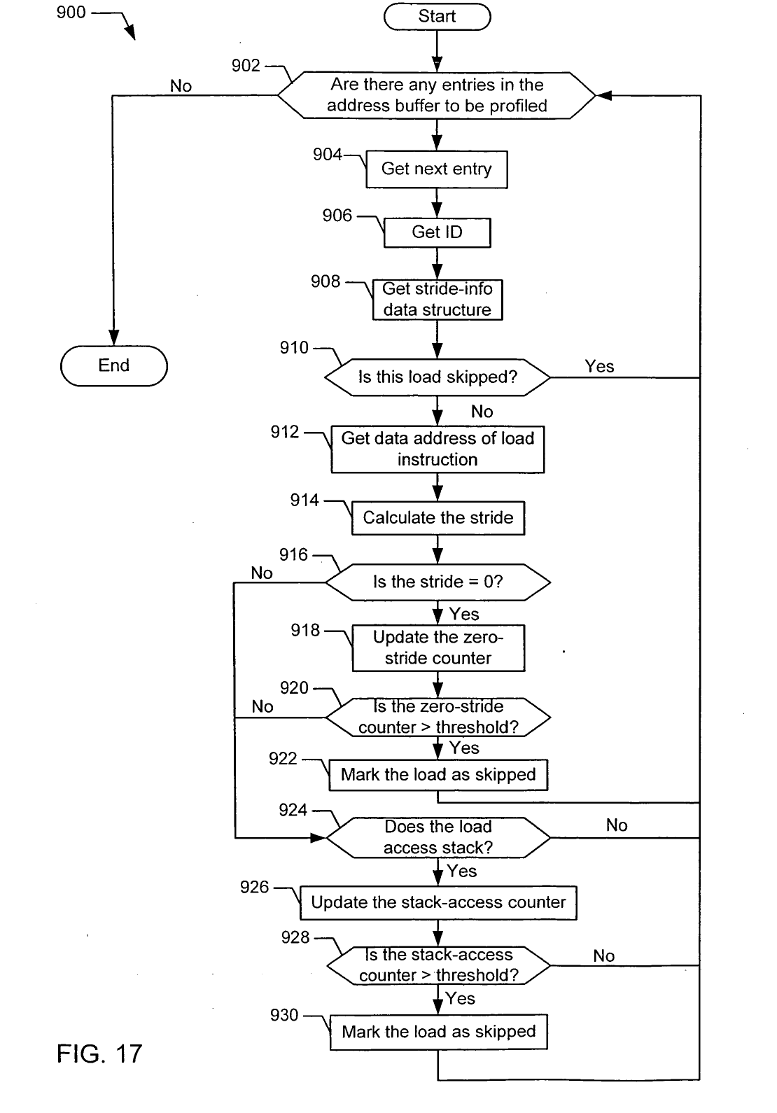

The example profiling process 800 of FIG. 16 begins by filtering out load instructions in the address buffer that do not meet predefined criteria (block 802). An example filtering process 900 is shown in FIG. 17. The example filtering process of FIG. 17 begins when the profiler 204 examines the address buffer for entries that have not already been examined (block 902). If entries remain in the address buffer that have not been processed (block 902), the profiler 204 gets the next entry from the address buffer (block 904) and retrieves the ID of the load instruction in the entry (block 906). The profiler 204 also retrieves a stride-info data structure (e.g., a data structure containing stride information associated with the ID contained within the profiling data structure) (block 908). The stride-info data structure may contain elements such as, but not limited to, a variable to indicate if the load is skipped (e.g., the load does not meet the predetermined criteria), a last address the load instruction accessed (e.g., a last-addr-value), a counter to indicate a number of zero-stride accesses (e.g., a zero-stride-counter), and a counter to indicate a number of stack accesses (e.g., a stack-access-counter).

By examining the stride-info data structure, the example profiler 204 is able to determine if the load instruction is a skipped load (e.g., a load instruction that accesses stack registers and/or has a loop invariant data address and therefore will not be prefetched) (block 910). If the load is a skipped load (block 910), control returns to block 902 where the profiler 204 determines if any entries remain in the address buffer. If the load instruction is not skipped (block 910), the profiler 204 retrieves the data address of the load instruction from the address buffer (block 912) and calculates the load instruction's stride (block 914). The load instruction's stride may be calculated by subtracting the last-addr-value from the data address of the load instruction.

If the load instruction's stride is zero (block 916), the profiler 204 updates the zero-stride counter (block 918) and compares the zero-stride counter to a zero-stride-threshold (block 920). If the zero-stride counter is greater than the zero-stride-threshold (block 920), the stride-info data structure is updated to indicate the load instruction is a skipped load (block 922) and control returns to block 902. If the stride of the load is non-zero (block 916) or if the zero-stride counter is less than or equal to the zero-stride-threshold (block 920), the profiler 204 next determines if the data address of the load instruction accesses the stack (block 924). One method to determine if the data address of the load instruction accesses the stack is to examine the registers the load instruction accesses and determine if a the data address is within the stack.

If the load instruction accesses the stack (block 924), the stack-access-counter is updated (block 926) and is compared to a stack-access-threshold (block 928). If the stack-access-threshold is less than the stack-access-counter (block 928), control returns to block 902 where the profiler 204 examines the address buffer to determine if there are any entries still remaining to be processed. Otherwise, the stride-info data structure is updated to indicate the load instruction is a skipped load (block 930). Control then returns to block 902 where the profiler 204 examines the address buffer to determine if there are entries still remaining to be processed. When all the entries of the address buffer have been examined (block 902), control returns to block 804 of FIG. 16.

At block 804, the profiler 204 collects self-stride profile information (e.g., a difference between data addresses of a load instruction during iterations of a loop) (block 804). An example self-profiling routine 1000 that may be executed to implement this aspect of the profiler 204 is shown in FIG. 18. The example self-profiling routine 1000 begins when the profiler 204 determines if any entries in the address buffer remain to be examined (block 1002). If all the entries in the address buffer have been examined (block 1002), control returns to block 806 of FIG. 16. Otherwise, the next entry from the address buffer and the corresponding ID are retrieved (blocks 1004 and 1006). The stride-info data structure associated with the ID is also retrieved (block 1008).

By examining the stride-info data structure, the profiler 204 is able to determine if the load instruction is a skipped load (block 1010). If the load is a skipped load (block 1010), control returns to block 1002 where the profiler 204 determines if any entries remain in the address buffer (block 1002). If the load instruction is not skipped (block 1010), the data address of the load instruction is retrieved from the address buffer (block 1012). The stride-info and the data address are used to profile the load instruction (block 1014). An example method to profile the load instruction is to calculate the stride of the load instruction (e.g., subtracting the last-addr-value from the data address of the load instruction), to save the stride of the load instruction in the stride-info data structure, and to identify the most frequently occurring strides. After profiling the load instruction (block 1014), control returns to block 1002 where the profiler 204 determines if any entries remain to be profiled in the address buffer (block 1002) as explained above.

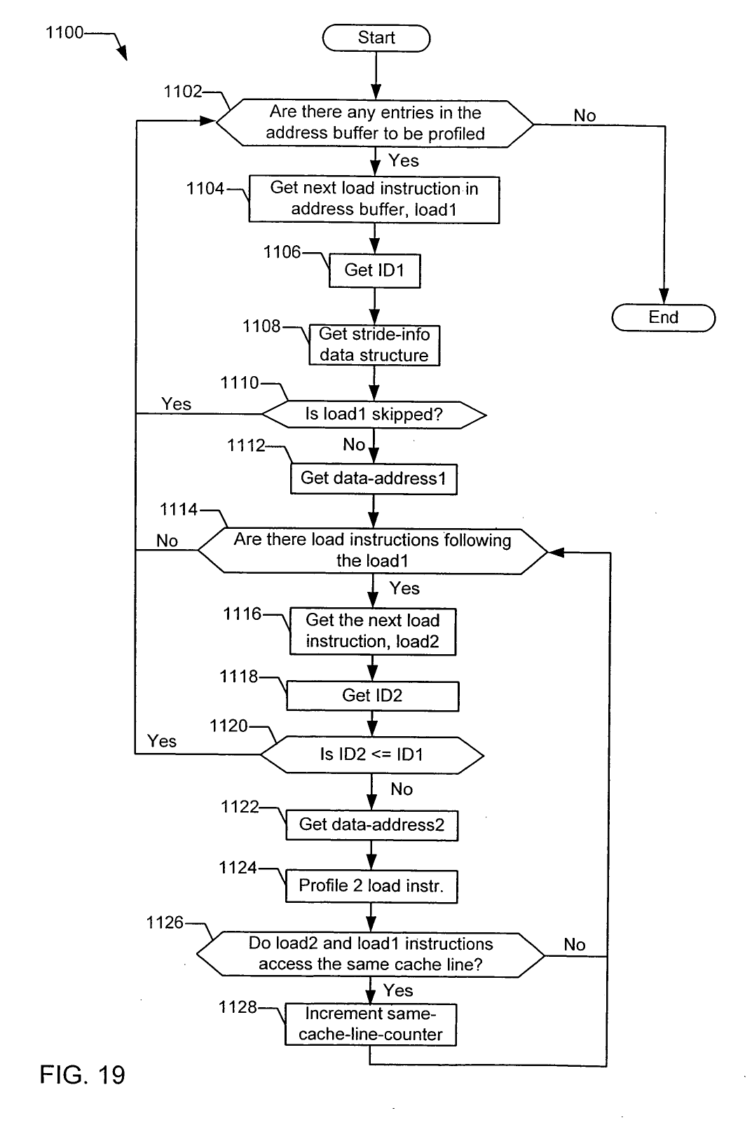

After the example self-profiling process 1000 completes (block 1002), control returns to block 806 of FIG. 16. At block 806, the profiler 204 collects cross-stride profile information (e.g., stride information with regard to two distinct load instructions) (block 806). An example cross-profiling routine 1100 which may be executed to implement this aspect of the profiler 204 is shown in FIG. 19. The example cross-profiling routine 1100 begins by determining if any entries in the address buffer remain to be examined (block 1102). If all the entries in the address buffer have been examined (block 1102), control returns to block 808 of FIG. 16. Otherwise, the next entry from the address buffer is retrieved (e.g., load1) (block 1104). The ID of load is also retrieved, referred to as ID1 (block 1106) and, the stride-info data structure associated with ID1 is also retrieved (block 1108).

The stride-info data structure is used to determine if the load instruction is a skipped load (block 1110). If the load is a skipped load, profiler 204 determines if any entries remain in the address buffer (block 1102). If the load is not a skipped load (block 1110), the profiler 204 retrieves the data address of the load instruction, referred to as data-address1 (block 1112).

The profiler 204 examines the address buffer for entries following the current entry (block 1114). If there are no entries in the address buffer following the current entry associated with ID1, control returns to block 1102. Otherwise, the profiler 204 examines the next entry, load2, in the address buffer (block 1116), and retrieves the ID associated with that load, referred to as ID2 (block 1118). ID2 is compared to ID1 (block 1120) and if ID2 is less than or equal to ID1, control returns to block 1102. As described earlier, ID's may be assigned from small to large within a hot loop. Therefore, if ID1 is greater than or equal to ID2, then the load associated with ID2 has already been profiled.

If ID2 is greater than ID1, the data address of load2 is retrieved from the address buffer, referred to as data-address2 (block 1122). Data-address2, data-address1, and a cross-stride-info data structure (e.g., a data structure to collect address differences between a pair of load instructions) are used to collect cross-stride profile information (block 1124). A difference between the two data addresses, data-address2 and data-address1, may be calculated and stored in the cross-stride-info data structure (block 1124). The cross-stride-info data structure is analyzed to determine the most frequently occurring differences existing between the data addresses (block 1124).

After collecting the cross-stride profile information, the profiler 204 collects information about the number of times a pair of load instructions has an address that accesses the same cache line (e.g., same-cache-line information). The profiler 204 examines load1 and load2 to determine if the pair of load instructions accesses the same cache line (block 1126). The profiler 204 may perform some calculation (e.g., an XOR operation and a comparison to the size of the cache line) on data-addr-1 and data-addr-2 and compare the result to the size of the cache line to determine if the two load instructions access the same cache line.

If load1 and load2 access the same cache line (block 1126), a counter associated with load1 and load2 to represent the number of times the pair of loads access the same cache line (e.g., a same-cache-line-counter) is incremented (block 1128). Otherwise, control returns to block 1114.

After the entries in the address buffer have been cross-profiled, the control returns to block 808 of FIG. 16. The profiler 204 resets the size of the address buffer (block 808) and control returns to block 728 of FIG. 14.

The profiler 204 then determines if the number of times the load instructions have been profiled is greater than a profile-threshold (e.g., a predetermined number of times instructions should be profiled). In the illustrated example, the number of times the load instructions have been profiled is determined via a counter (e.g., a profiling-counter). In particular, the profiling-counter is incremented each time the profiling information is collected (block 728) and the value of the counter is compared to a profiling-threshold (block 730). A person of ordinary skill in the art will readily appreciate the fact that the counter may be initialized to a value equal to the profiling-threshold and decremented each time the profiling information is collected until the counter value equals zero. If the profiler 204 determines the profiling-counter value is less than the profile-threshold (block 730), control returns to block 721. Otherwise, control returns to block 412 of FIG. 4.

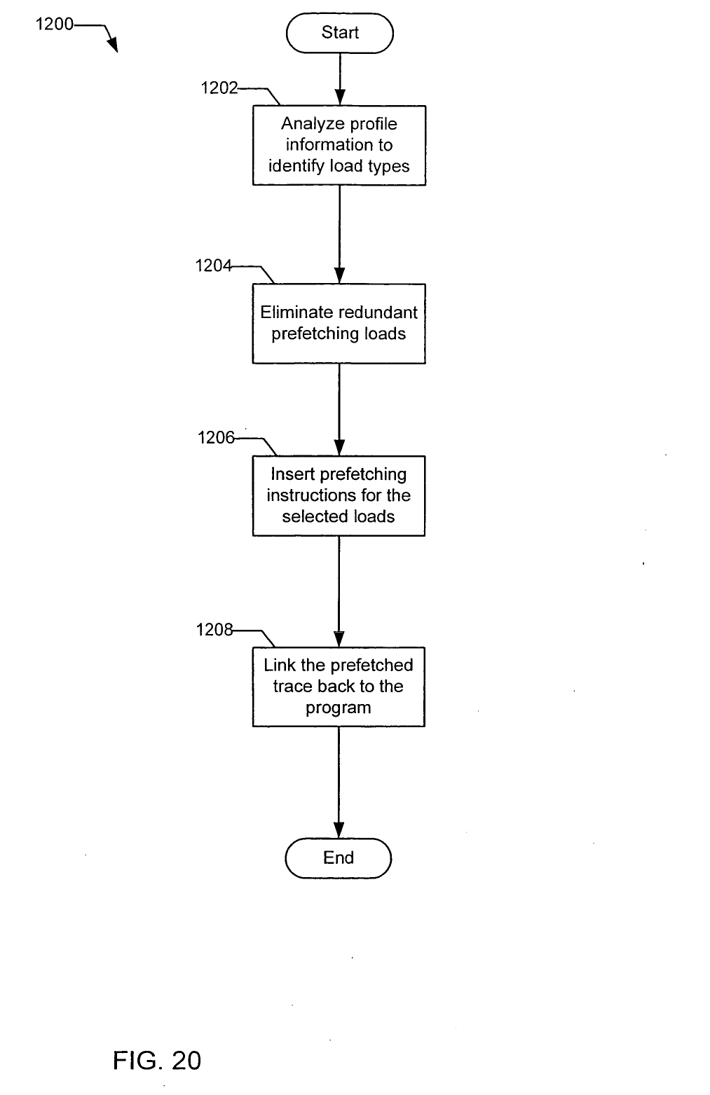

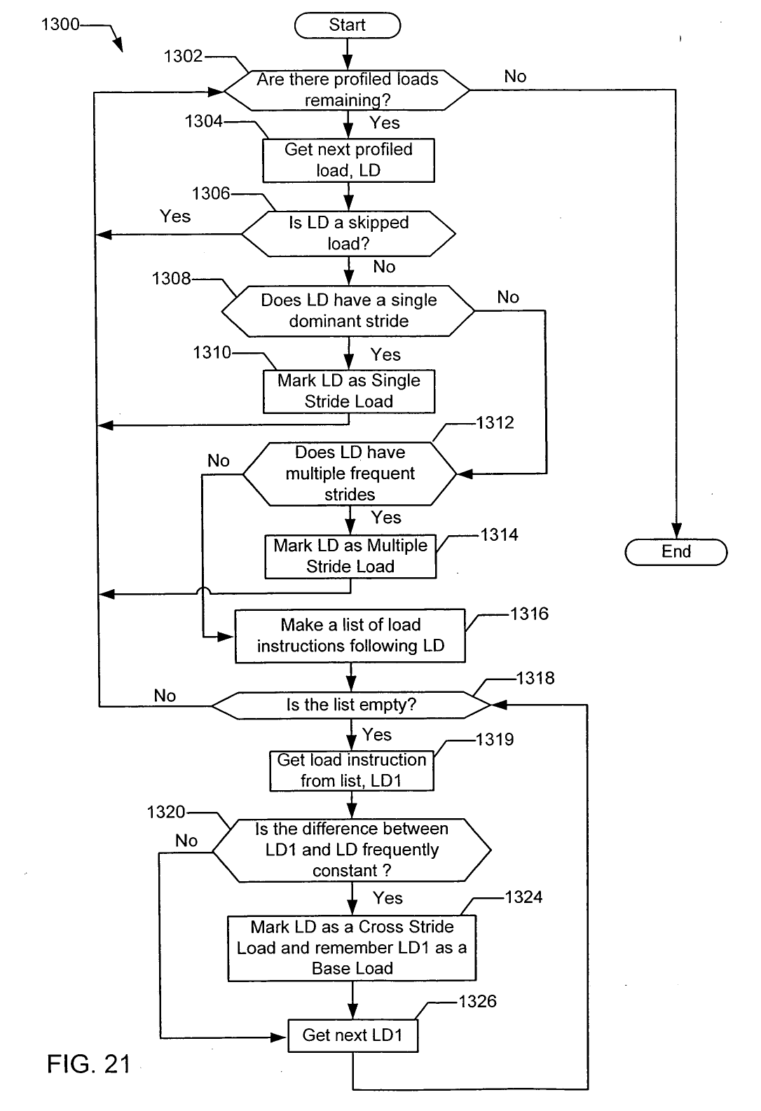

Returning to block 412 of FIG. 4, a use-translation phase begins (block 412) after the optimization candidate has been gen-translated (block 410). The example use-translation process 1200 of FIG. 20, which may be executed to implement the use-translation module 112, begins by analyzing the profile information (block 1202). The profile information may be analyzed using the example process 1300 of FIG. 21, which may be executed to implement the profile analyzer 302. The profile analyzer 302 begins by determining if there are profiled load instructions remaining to be analyzed (block 1302). If there are no remaining load instructions to be analyzed (block 1302), control returns to block 1204 of FIG. 20. If there are load instructions remaining (block 1302), the profiler 204 begins analyzing a load instruction, LD (block 1304) and determines if LD is a skipped load instruction (block 1306). If LD is a skipped load instruction (block 1306), control returns to block 1302. If LD is not a skipped load instruction (block 1306), the profile analyzer 302 examines the profile information in order to determine if LD has a single dominant stride (e.g., a stride value that occurs significantly more frequently than other stride values between multiple executions of a load instruction) (block 1308). If LD has a single dominant stride, the profile analyzer 302 marks LD as a single stride load instruction (block 1310). Control then returns to block 1302.

If LD does not have a single dominant stride (block 1308), the profile analyzer 302 examines the profile information to determine if LD has multiple frequent strides (e.g., a multiple dominant stride load) (block 1312). If LD has multiple frequent strides (block 1312), LD is marked as a multiple stride load instruction (block 1314) and control returns to block 1302. If LD does not have multiple frequent strides (block 1312), the profile analyzer 302 tests LD to determine if it is a cross stride load. The profile analyzer 302 finds all load instructions following LD in the trace and creates a subsequent load list (block 1316). The subsequent load list may be created by examining the address buffer to find the load instructions in the buffer that come after LD. The profile analyzer 302 examines the subsequent load list and retrieves the first load instruction in the subsequent load list that has not yet been examined (LD1) (block 1319). If the difference between LD's data address and LD1's data address is frequently constant (block 1320), then the profile analyzer 302 marks the load instruction LD as a cross stride load instruction and LD1 as a base load of the cross stride load instruction (block 1324). If the difference is not frequently constant (block 1320), the profile analyzer 302 retrieves the next load instruction in the subsequent load list following the current LD1. Blocks 1318, 1319, 1320, 1324, and 1326 are repeated until all load instructions in the subsequent load list are analyzed. After all the load instructions in the subsequent load list have been examined (block 1318), control returns to block 1302. For ease of discussion, the load instructions marked as a single stride load instruction, a multiple stride load instruction, a cross stride load instruction, and a base load of the cross stride load instruction are referred to as prefetch load instructions.

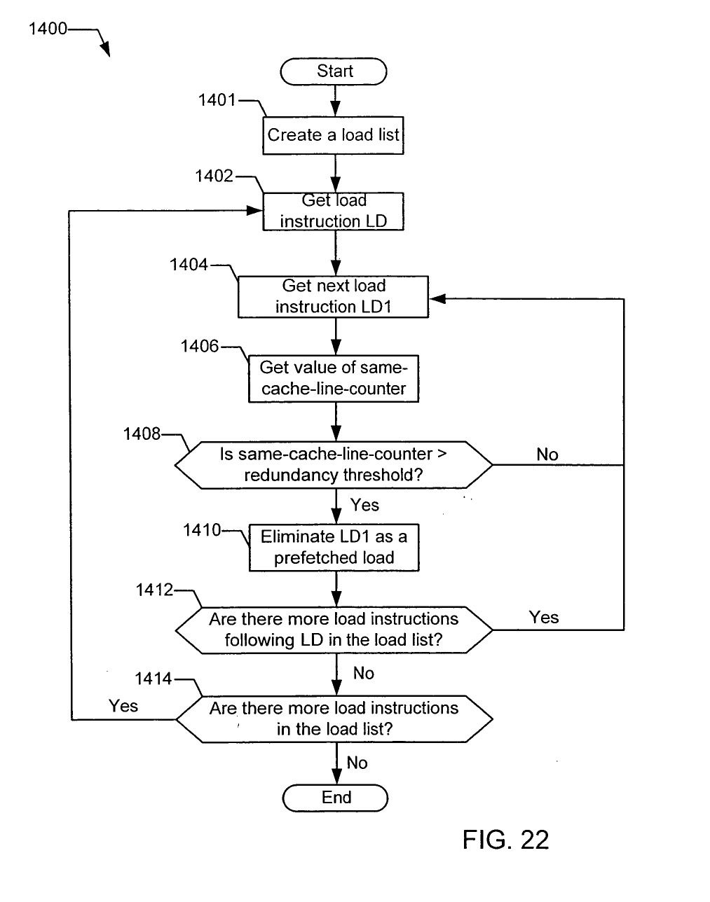

Returning to FIG. 20, after the profiling information of the load instructions have been analyzed (block 1202), the intermediate representaion generator 109 generates an IR of the optimization candidate and the prefetch module 304 eliminates redundant prefetch load instructions (e.g., load instructions that frequently access the same cache line) (block 1204) to reduce ineffective prefetching. An example process 1400, which may be implemented to execute the prefetch module 304 to eliminate redundant prefetching is illustrated in FIG. 22.

The example process 1400 eliminates redundant prefetching by examining possible pairings of prefetch load instructions in the hot loop (e.g., pairs of load instructions LD and LD1). The prefetch module 304 begins by creating a list of prefetch load instructions in the hot loop (e.g., a load list) (block 1401) and retrieves the first load instruction in the load list that has not been analyzed (LD) (block 1402). The prefetch module 304 examines the list of load instructions following the current LD in the load list and retrieves the next load instruction in the load list that has not been analyzed (LD1) (block 1404). The value of the same-cache-line-counter of the pair of loads (LD, LD1) is retrieved (block 1406) and compared to a redundancy-threshold (block 1408). If the same-cache-line-counter is larger than the redundancy-threshold (block 1408), the prefetch module 304 eliminates the current LD1 as a prefetched load (block 1410). Otherwise, control returns to block 1404. After the current LD1 has been eliminated as a prefetch load instruction (block 1410), the prefetch module 304 determines if there are any more load instructions following LD in the load list to be analyzed (block 1412). If there are load instructions following LD remaining in the load list (block 1412), blocks 1404, 1406, 1408, 1410 and 1412 are executed. Otherwise, the prefetch module 304 determines if there are any load instructions remaining in load list yet to be analyzed (block 1414). If there are LD instructions remaining in the load list (block 1414), blocks 1402, 1404, 1406, 1408, 1410, 1412, and 1414 are executed. Otherwise, control advances to block 1206 of FIG. 20.

After the redundant prefetched loads have been eliminated (block 1204), the prefetch module 304 examines each load instruction's type in order to properly calculate the data address of the load instruction and inserts prefetching instructions for the prefetch load instructions into the IR (block 1206). Each load type (e.g., single stride load, multiple stride load, cross load, and base load for a cross stride load) may require different instructions to properly prefetch the data due to the differences in the stride pattern. For example, a single stride load calculates the prefetch address by adding the single stride value (possibly scaled by a constant) to the load address. On the other hand, a single stride load that is also a base load for a cross stride load requires an additional calculation (e.g., addition of the value of the cross load's offset from the base load to the address of the single stride load) for each cross stride load the single stride load is a base load for.

Finally, the intermediate representation module 109 translates the IR of the prefetched loop into a native prefetched loop. The code linker 113 links the native prefetched loop back into the native program (block 1208). The code linker 113 may link the prefetched loop back into the program by modifying the original branch instruction such that the target address of the branch instruction points to the start address of the prefetched loop. The native prefetched loop is now able to be executed directly by the native program.

FIG. 23 is a block diagram of an example computer system which may execute the machine readable instructions represented by the flowcharts of FIGS. 4, 5, 6, 7, 11, 13, 14, 15, 16, 17, 18, and/or 19 to implement the apparatus 100 of FIG. 1. The computer system 2000 may be a personal computer (PC) or any other computing device. In the example illustrated, the computer system 2000 includes a main processing unit 2002 powered by a power supply 2004. The main processing unit 2002 may include a processor 2006 electrically coupled by a system interconnect 2008 to a main memory device 2010, a flash memory device 2012, and one or more interface circuits 2014. In an example, the system interconnect 2008 is an address/data bus. Of course, a person of ordinary skill in the art will readily appreciate that interconnects other than busses may be used to connect the processor 2006 to the other devices 2010, 2012, and 2014. For example, one or more dedicated lines and/or a crossbar may be used to connect the processor 2006 to the other devices 2010, 2012, and 2014.

The processor 2006 may be any type of well known processor, such as a processor from the Intel Pentium® family of microprocessors, the Intel Itanium® family of microprocessors, the Intel Centrino® family of microprocessors, and/or the Intel XScale® family of microprocessors. In addition, the processor 106 may include any type of well known cache memory, such as static random access memory (SRAM). The main memory device 2010 may include dynamic random access memory (DRAM) and/or any other form of random access memory. For example, the main memory device 2010 may include double data rate random access memory (DDRAM). The main memory device 2010 may also include non-volatile memory. In an example, the main memory device 2010 stores a software program that is executed by the processor 2006 in a well known manner. The flash memory device 2012 may be any type of flash memory device. The flash memory device 2012 may store firmware used to boot the computer system 2000.

The interface circuit(s) 2014 may be implemented using any type of well known interface standard, such as an Ethernet interface and/or a Universal Serial Bus (USB) interface. One or more input devices 2016 may be connected to the interface circuits 2014 for entering data and commands into the main processing unit 2002. For example, an input device 2016 may be a keyboard, mouse, touch screen, track pad, track ball, isopoint, and/or a voice recognition system.

One or more displays, printers, speakers, and/or other output devices 208 may also be connected to the main processing unit 2002 via one or more of the interface circuits 2014. The display 2018 may be a cathode ray tube (CRT), a liquid crystal displays (LCD), or any other type of display. The display 2018 may generate visual indications of data generated during operation of the main processing unit 2002. The visual indications may include prompts for human operator input, calculated values, detected data, etc.

The computer system 2000 may also include one or more storage devices 2020. For example, the computer system 2000 may include one or more hard drives, a compact disk (CD) drive, a digital versatile disk drive (DVD), and/or other computer media input/output (I/O) devices.

The computer system 2000 may also exchange data with other devices 2022 via a connection to a network 2024. The network connection may be any type of network connection, such as an Ethernet connection, digital subscriber line (DSL), telephone line, coaxial cable, etc. The network 2024 may be any type of network, such as the Internet, a telephone network, a cable network, and/or a wireless network. The network devices 2022 may be any type of network devices 2022. For example, the network device 2022 may be a client, a server, a hard drive, etc.

Persons of ordinary skill in the art will appreciate that the methods disclosed may be modified such that some or all of the various optimizations (e.g., hot translation, use-translation, and/or gen-translation) may be executed in parallel of the execution of the native software. Example methods to implement the parallel optimization and execution of native program instructions include, but are not limited to, generating new execution threads to execute the hot loop identifier 108, the gen-translation module and/or the use-translation module 112 in a multi-threaded processor and/or operating system, using a real time operating system and assigning the hot loop identifier 108, the gen-translation module 110 and/or the use-translation module 112 to a task, and/or using a multi-processor system.

In addition, persons of ordinary skill in the art will appreciate that, although certain methods, apparatus, and articles of manufacture have been described herein, the scope of coverage of this patent is not limited thereto. On the contrary, this patent covers all apparatuses, methods and articles of manufacture fairly falling within the scope of the appended claims either literally or under the doctrine of equivalents.

1. A method to optimize a program comprising:
cold translating a program from a first language to a second language;
determining a cold execution trip count;
inserting instructions to calculate a hot execution trip count if the cold execution trip count is less than a predetermined trip count threshold;
identifying a loop in the translated program that is a candidate for optimization using profile data;
inserting instrumentation into the loop to develop profile data; and
inserting a prefetching instruction into the loop if the profile data indicates a load instruction in the loop meets a predefined criteria.

2. A method as defined in claim 1 wherein inserting instrumentation into the loop comprises:
finding a load instruction in the loop; and
inserting a first instruction sequence to record addresses associated with the load instruction.

3. A method as defined in claim 2 wherein the first instruction sequence causes the addresses to be recorded in a buffer associated with the loop, and inserting instrumentation into the loop further comprises:
inserting a second instruction sequence into the loop to trigger processing of the addresses in the buffer to determine if the profile data indicates a load instruction in the loop meets a predefined criteria.

4. A method as defined in claim 1 wherein profile data identifies the load instruction as at least one of a single stride load, a multiple stride load, a cross stride load, and a base load of a cross stride load.

5. A method to optimize a program comprising:
cold translating the program from a first instruction set to a second instruction set;
executing the translated program;
identifying a hot loop in the translated program that meets a first predefined criteria;
gen-translating the hot loop; and
if the hot loop meets a second predefined criteria, use-translating the hot loop.

6. A method as defined in claim 5 wherein cold translating the program comprises:
identifying a block in a foreign program;
inserting instructions to update a first counter into an instruction block to determine the number of times the instruction block is executed; and
analyzing the first counter to determine if the block is a candidate for optimization.

7. A method as defined in claim 5 wherein gen-translating and use-translating the program each comprises translating the first instruction set to an intermediate instruction set and translating the intermediate instruction set to the second instruction set.

8. A method as defined in claim 7 wherein the intermediate instruction set comprises an instruction set different than the first instruction set and different than the second instruction set.

9. A method as defined in claim 5 wherein identifying the hot loop in the translated program comprises conditioning a loop by a least common specialization operation.

10. A method as defined in claim 9 wherein the least common specialization operation comprises:
identifying a block of instructions that is a least common denominator block with other loops;
rotating the loop such that the least common denominator block is a head of the loop.

11. A method as defined in claim 5 wherein identifying the hot loop in the translated program comprises:
using at least one of a cold execution trip count to determine the average number of times the hot loop is executed during cold execution or a hot execution trip count to determine the number of times the hot loop is executed.

12. A method as defined in claim 11 wherein the cold trip count comprises instructions to determine the frequency a loop entry block is taken and the frequency the loop back edge is taken.

13. A method as defined in claim 11 wherein the hot loop is gen-translated if the hot loop contains a load instruction and a value of at least one of a hot trip count and a cold trip count is greater than a predetermined threshold.

14. A method as defined in claim 13 wherein the hot loop is only gen-translated if the load instruction does not access data in a stack or have a loop invariant load address.

15. A method as defined in claim 13 wherein the hot loop is optimized by a normal hot translation if the cold trip count is less than the predetermined threshold.

16. A method as defined in claim 5 wherein gen-translating comprises:
identifying a load instruction within the hot loop;
inserting a profiling instruction in association with the load instruction;
inserting a profiling control instruction in a loop entry block of the loop to control the number of times the load instruction is profiled;
executing the profiling instruction to profile the load instruction; and
executing the profiling control instruction to determining if the load has been profiled more than a predetermined number of times.

17. A method as defined in claim 16 wherein the profiling instruction comprises an instruction to assign the load instruction a unique identification number and an instruction to collect profiling information.

18. A method as defined in claim 17 wherein the unique identification number is stored with a data address of the load instruction.

19. A method as defined in claim 16 wherein the profiling information comprises stride information.

20. A method as defined in claim 16 wherein the profiling control instruction comprises a counter to determine how many times the load instruction has been profiled.

21. A method as defined in claim 5 wherein use-translating comprises:
analyzing the profile information; and
inserting a prefetching instruction for the load instruction.

22. A method as defined in claim 21 further comprising eliminating redundant prefetched loads.

23. A method as defined in claim 21 wherein analyzing the profile information comprises determining if the load instruction is at least one of: a single stride load, a multiple stride load, a cross stride load; and a base load.

24. A method as defined in claim 5 further comprising linking the use-translated hot loop into the native program.

25. An apparatus to optimize a program comprising:
a cold translator to translate the program from a first instruction set to a second instruction set;
a hot loop identifier to identify a hot loop in the translated program and to determine if the hot loop should be gen-translated.;
a gen-translator to instrument the hot loop with instructions to collect profile information; and
a use-translator to optimize an instruction associated with the hot loop if the profile information determines that the hot loop should be optimized.

26. An apparatus as defined in claim 25 wherein the hot loop identifier identifies a loop as a hot loop by:
counting a number of times an instruction block associated with the loop is executed;
determining an average number of times the loop is executed; and
comparing the average number of times the loop is executed to a predetermined threshold.

27. An apparatus as defined in claim 25 wherein the hot loop identifier identifies a hot loop in the translated program by conditioning a loop by a least common specialization operation.

28. An apparatus as defined in claim 27 wherein the least common specialization operation comprises:
identifying a block of instructions that is a least common denominator block with other loops;
rotating the loop such that the least common denominator block is a head of the loop.

29. An apparatus as defined in claim 25 wherein the gen-translator and the use-translator each translates the program from the first instruction set to an intermediate instruction set and from the intermediate instruction set to the second instruction set.

30. An apparatus as defined in claim 25 wherein the gen-translator comprises:
a load instruction identifier to identify a load instruction within the hot loop and having at least one predetermined characteristic;
a profiler to insert profiling instructions into the hot loop if the load instruction identifier identifies a load instruction within the hot loop having the at least one predetermined characteristic.

31. An apparatus as defined in claim 30 wherein the profiler collects stride information for the load instruction.

32. An apparatus as defined in claim 25 wherein the use-translator comprises:
a profile analyzer to determine a load instruction type for the load instruction based on the profile data;
an optimizer to insert a prefetch instruction into the loop for the load instruction; and
a code linker to couple the hot loop to the program.

33. An apparatus as defined in claim 32 wherein the optimizer determines an address to be prefetched based on the load instruction type.

34. An apparatus as defined in claim 32 wherein the load instruction type comprises at least one of: a single stride load, a multiple stride load, a cross stride load, and a base load of a cross stride load.

35. A machine readable medium storing instructions structured to cause a machine to:
cold translate a program from a first language to a second language;
determine a cold execution trip count;
insert instructions to calculate a hot execution trip count if the cold execution trip count is less than a predetermined trip count threshold;
identify a loop in the translated program;
insert instrumentation into the loop to develop profile data if the hot execution trip count associated with the loop exceeds a predetermined threshold; and
insert a prefetching instruction into the loop if the profile data indicates a load instruction in the loop meets a predefined criteria.

36. A machine readable medium as defined in claim 35 wherein the load instruction comprises at least one of: a single stride load, a multiple stride load, a cross stride load, and a base load of the cross stride load.
